(19) United States
(12) Patent Application Publication
(10) Pub. No.: US 2002/0116123 A1
(43) Pub. Date: Aug. 22, 2002

(54) System and method for event execution responsive to roving unit location

(76) Inventors: Steve C. Lampe, Ft. Calhoun, NE (US); Royce Connerley, Bellevue, NE (US)

Correspondence Address: Andre M. Szuwalski, JENKENS & GILCHRIST,P.C., 3200 Fountain Place, 1445 Ross Avenue, Dallas, TX, 75202-2799, US

(21) Appl. No.: 09/790,989

(22) Filed: Feb. 21, 2001

(51) Int. Cl. G01C 21/26

(52) U.S. Cl. 701/213; 342/357.07; 340/988

(57) ABSTRACT

A method and system to execute an event responsive to a roving unit being located within a certain region are described. In a method embodiment, the location of a roving unit is determined and a defined geographic region in which the roving unit lies is determined. An event is then identified, wherein the event has been defined to be executed when the roving unit is located within the defined region. Finally, the identified event is executed.

### FIELD OF THE INVENTION

The present invention relates to location-based event execution systems and methods. In particular, but not by way of limitation, the present invention relates to systems and methods for executing software and hardware events responsive to a determination that a roving unit is within a certain geographic region.

### BACKGROUND OF THE INVENTION

It is recognized that location often plays a key role in the operation of certain electronic and computer-based devices. For example, a multi-mode device may be configured such that only certain ones of the modes should be used at any given location. Alternatively, only certain ones of those modes may be supported for use at given location. Effective control over device operation is thus directly tied to device location.

In many instances, controlling the device based on location becomes a manual task. That is, the device operator must first recognize where the device is located and then exercise control over its configuration (for example, mode as referred to above) based on that location such that the device will properly operate. Such manual control, however, is inherently subject to error and thus there is a need for a mechanism to effectuate automatic control over device operation (for example, in the execution of a certain event) responsive to either a location determination or a change in determined location.

A better understanding of the problem and need may be obtained by reference to a specific example. Consider an engineer in operation of a railroad locomotive. The engineer is in contact with a central dispatcher via radio frequency communications. As that locomotive moves along the track, it moves in and out of the radio frequency coverage area of different base station sites. Each of these sites, in order to avoid interference issues, operates on a different frequency. If the engineer desires to maintain constant capability for communication with the dispatcher, the engineer must manually re-tune the radio as the locomotive moves through and between base station radio frequency coverage areas. This manual re-tune operation tends to distract the engineer from the task of operating the locomotive and requires the engineer to have access to precise information concerning the relation between the current location of the locomotive and the available base station within communications range.

The prior art presents a simplistic approach to changing the channels of an APCO25 compliant radio at the appropriate times. This solution involves triggering channel change based on distance measurements (i.e., how far is the radio from the surrounding base stations) and/or signal strength measurements (i.e., from which tower is the strongest signal received.) For example, see U.S. Pat. No. 5,857,155 entitled “Method and Apparatus for Geographic Based Control in a Communication System”. Although somewhat effective, this simplistic solution is not completely satisfactory. For example, distance based channel selection systems do not take into account attenuation due to terrain changes. Signal strength based channel selection systems do not take into account temporary variances in signal strength. In each case, the result is unnecessary or untimely channel changes.

### SUMMARY OF THE INVENTION

To remedy the deficiencies of existing systems and methods, the present invention provides a method and apparatus to execute an event responsive to a roving unit, such as a locomotive, mobile professional, cab, delivery vehicle, barge, tug boat, and the like, being located within a certain region. In one of the many embodiments, the present invention can include a radio operable in at least a first mode and a second mode. The radio can be configured to communicate with a first base station associated with a first geographic region when the radio is operating in the first mode, and the radio can be configured to communicate with a second base station associated with a second geographic region when the radio is operating in the second mode. This embodiment also includes a location determining means (such as a GPS receiver, a differential GPS receiver, a triangulation system, etc.) configured to determine the geographic location of the radio. Additionally, a logic device can be connected to the radio and to the location determining means. The logic device can be configured to change the operation of the radio between the first mode and the second mode responsive to the location determining means determining that the geographic location of the radio is within the second region.

As an alternative embodiment, the logic device can respond to a particular geographic coordinate determined by the location determining means and convert that geographic coordinate to a more human friendly and recognizable place name. This operation need not necessarily be associated with a change in radio mode. The place name may be communicated over the radio and/or displayed for viewing.

As yet another alternative embodiment, the radio operates in a first mode to instigate sending of data communications and a second mode to terminate sending of data communications. The logic device can be configured to change the operation of the radio between the first mode and the second mode responsive to geographic location determined by the location determining means. More specifically, the radio operates in the first mode when the determined geographic location is within a certain geographic region, and operates in the second mode when it moves outside of the geographic region.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a flowchart of the basic operation of the present invention;

FIG. 2 illustrates a block diagram of a system constructed according to the principles of the present invention;

FIG. 3 illustrates a representative region map; and

FIG. 4 is a flowchart of another application of the present invention.

### DETAILED DESCRIPTION

Although the present invention is open to various modifications and alternative constructions, a preferred exemplary embodiment that is shown in the drawings is described herein in detail. It is to be understood, however, that there is no intention to limit the invention to the particular forms disclosed. One skilled in the art can recognize that there are numerous modifications, equivalences and alternative constructions that fall within the spirit and scope of the invention as expressed in the claims. Additionally, the present invention should not be limited to addressing those issues described in the above Background section. The present invention can easily address numerous other issues and problems.

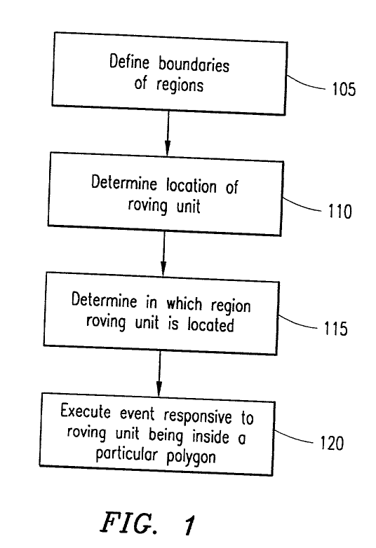

Referring now to FIG. 1, there is shown a flowchart illustrating the basic operation of the present invention. In this embodiment, physical, geographic regions taking the shape of polygons, circles, ellipses, and/or irregular curved shapes can be defined as corresponding to particular physical locations (step 105).

The defined regions of the present invention can be grouped into two types—although more or less types can be used as needed. In the embodiment described with relation to FIG. 1, the two types of regions defined in step 105 include RF-performance-prediction based regions and user-defined regions. The RF-performance-prediction regions define a geographic area referred to as a 90% confidence contour (the percentage can be varied) in which there is a 90% first time chance that a communication device within that region will successfully communicate with a certain base station assigned to that region. These confidence contours can be calculated using topographic data, land-use data, vegetation data, land-type data and other similar data that indicates and/or accounts for potential interference with a wireless signal. The RF regions may further be defined by a certain place name (such as “Region Alpha” or a regional or geographic map identifier like a county, town or municipal designator).

With regard to the second type of defined regions, the user-defined region, it is a region defining an area of interest to the user such as a train switching yard, an interchange point, a fuel depot, a plant, a transportation zone, etc. The user-defined region can at least be defined by a standard polygon and/or by defining a distance-radius or time-radius from a particular point. For example, the user-defined region could be dynamically defined in that it is defined by the velocity and heading of a roving unit. This type of dynamically-defined region is particularly useful when a customer wants to know that a roving unit will be at a particular point, for example, a plant location, in 30 minutes. With regard to the railroad industry in particular, such a dynamically-defined region could be used to notify a plant manager that his box cars will arrive at the plant in 30 minutes. Alternatively, a distance radius can be used to notify the plant manager that his box cars are concurrently located, for example, within 15 miles of the plant. The user defined region may further be defined by certain place name (such as “City Yard,” or “Smith Depot”).

Still referring to FIG. 1, as the roving unit moves from one location to another, its coordinates can be determined (step 110). In one embodiment, the coordinates of the roving unit can be determined using GPS and/or differential GPS (DGPS). Other location systems, such as triangulation systems, can also be used to determine the location of the roving unit.

Once the location of the roving unit is determined, the related location data is used to determine within which of the defined region(s) (as determined in step 105) the roving unit is currently located (step 115). (This determination can be made by any one of various well-known mathematical techniques.) The frequency and timing of the location determination (step 110) and/or the region location determination (step 115) can be varied according to particular needs. In one embodiment, for example, the step of determining the location of the roving unit and/or the step of determining within which region the roving unit is located can be performed at select time intervals. The length of this time interval can be adjusted as the roving unit approaches a boundary of a region or approaches some other triggering point. In another embodiment, steps 110 and 115 can be triggered at a select time responsive, for example, to a location prediction. That is, if a roving unit is predicted to be at a particular point at a particular time based upon the roving unit's last known heading and velocity, then at that particular time, one or both of steps 110 and 115 can be initiated.

Once that it has been determined that the roving unit is within a particular region(s), the roving unit executes an event responsive to that determination (step 120). For example, in accordance with one embodiment, assume that it is determined that the roving unit has moved from one RF-performance-prediction based region to another RF-performance-prediction based region. At this time, it may be appropriate to change the radio channel to correspond to the base station associated with the new region. Thus, the radio may be changed from a first mode (wherein communication is effectuated on first RF channel with an associated base station for a first RF-performance-prediction based region) to a second mode (wherein communication is effectuated on second RF channel with an associated base station for a second RF-performance-prediction based region).

Although the present invention has been generally described with relation to changing radio channels as a roving unit moves from the coverage area of one base station to the coverage area of another base station, one skilled in the art can recognize that other adaptations of the present invention are available. For example, in another embodiment, the executed event could involve notifying a particular person of the roving unit's location. As previously described, a plant manager could be notified that a train (the roving unit), for example, is within 10 minutes or 10 miles of the plant. Other adaptations include notifying someone that a train, cab or similar roving unit has crossed from a first zone to a second zone. In yet other embodiments the time interval for executing steps 110 and 115 can be increased or decreased based on the step 115 determination and step 120 execution. For example, it might be necessary to track the location of a train in a switching yard at a higher time resolution than a train merely crossing a certain state. In other embodiments, the method of determining the location of the roving unit can be changed as the roving unit travels from one region to another. That is, the roving unit's location might be determined by standard GPS within a first region, and by DGPS (with a much higher degree of resolution) within a second region (for example, a railroad yard or dispatch area). Other embodiments include methods and systems for reporting sensor readings and location readings by user-defined names rather than coordinates. In still another embodiment, the location determination may prompt the communication of the place name associated with the region. Such a communication may be made using the radio and/or through a visual display. An advantage with this implementation is that reports may be generated from mobile operation with location data in a format (i.e., a place name) that is easier for human interpretation and understanding. Furthermore, in another embodiment, the location determination may be used to trigger or terminate radio operation to communicate data. In this configuration, communication may be made when located within a certain region and terminated when leaving that region.

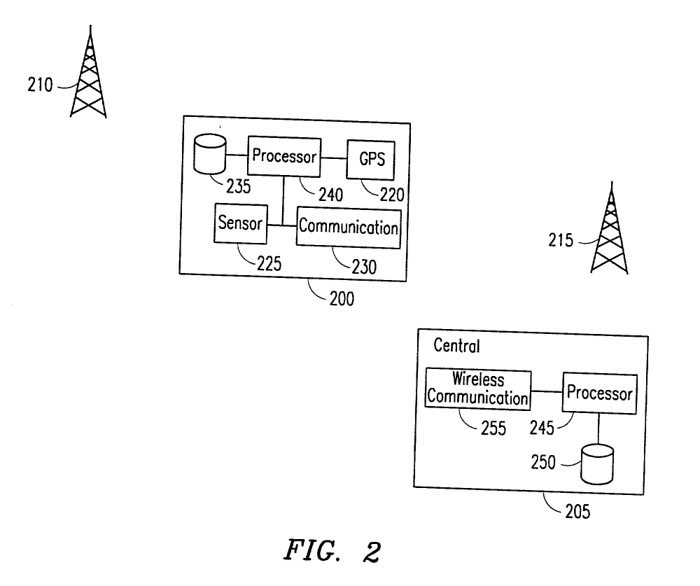

Referring now to FIG. 2, there is illustrated a block diagram of a system constructed in accordance with the principles of the present invention. This system includes a roving unit 200, a central unit 205, a first base station 210 and a second base station 215. (Other embodiments, however, can include various combinations of these and/or other elements). In this embodiment, the roving unit 200, which can be a train, mobile professional (human being), delivery truck, cab, barge, tug boat, or the like, includes a GPS receiver 220, a sensor device 225, a communication device 230 and a storage device 235, all of which are connected to a processor 240.

In operation, the GPS receiver 220 receives location information and passes that information to the processor 240. The processor 240 can then retrieve region definitions from the storage device 235 and determine within which region, if any, the roving unit 220 is located. Next, the processor 240 can take a particular action based upon the region in which the roving unit 220 is located. These actions have, in an exemplary fashion, been described above. The processor is programmed to make appropriate location influenced decisions as to an action to be taken.

In an alternate embodiment, after the GPS receiver 220 receives location information, it passes that information to the processor 240. The processor can then send that location information through the wireless communication device 230 to the central unit 205. Upon receiving the roving unit's location, the processor 245 at the central unit 205 can compare the location data against the region definitions stored in the storage device 250 and determine within which region(s) the roving unit 200 lies. The central unit's processor 245 can then transmit this data and, optionally, other additional location dependent information, through the wireless communication device 255 to the roving unit 200, which can then act upon that data (in accordance with its programmed response). Alternatively, the central unit's processor 245 can directly take action, and/or it can send instructions directly to the roving unit's processor 240 regarding the actions to take. For example, the central unit's processor 245 could instruct the mobile unit's processor 240 to take a sensor reading and either store the reading locally or transmit the data back to the central unit 205.

As one skilled in the art can understand, the embodiment in the present invention as described above can be adapted in several fashions. For example, the system could be designed to change the channels of the roving unit's communication device 230, or the system could be designed to merely report readings taken by the sensor device 225. Other adaptations eliminate the central unit 205 and/or replace the GPS receiver 220 with other types of location determining devices.

Any suitable processing operation may be utilized to determine whether the identified geographic position is located within a region of interest. In accordance with a preferred embodiment of the invention, an infinitely extending ray is drawn from the point of the identified geographic position and a determination is made as to how many sides of the defined region of interest (typically comprising a polygon but possibly comprising other shapes as well that are perhaps approximated as polygons) that the ray intersects. If the ray intersects an even number of sides of the region, then the point (geographic position) must be located outside the region. If odd, on the other hand, the point must be located within the region. This determination technique advantageously may be quickly and simply implemented by the processing unit (either at the mobile or at the base). Other advantages of this technique include that it is not limited to use with convex polygon shapes and is also useful with respect to polygons with inside holes.

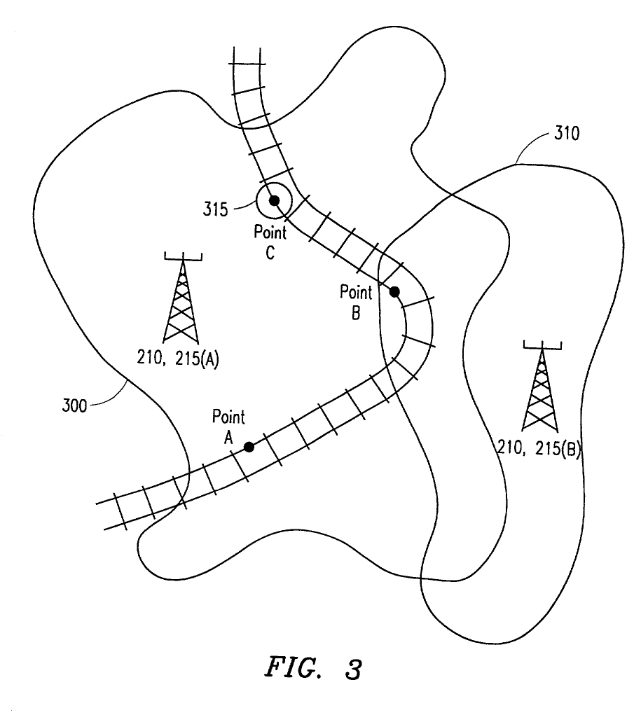

Referring now to FIG. 3, it illustrates a representative region map that includes regions 300 and 310 and circular region 315. (The regions illustrated by the map can be represented by digital data in a variety of well known ways.) In this embodiment regions 300 and 310 represent RF-performance-prediction based regions and region 315 represents a user-defined region. Each of the RF-performance-prediction based regions are associated with a particular base station such that a wireless communication device within a particular region can communicate with the associated base station (see FIG. 2) with a 90% first time talk success rate.

In operation, a roving unit (such as a train) may initially determine that it is located at point A along track 302 and, for example, select base station's 210, 215(A) radio channel A (which is associated with region 300). At the next data collection interval, the roving unit may determine that it has moved along track 302 and is now located at point B. Because point B is within plural regions 300 and 310, the roving unit's radio can be tuned to any one of the channels supported by the base stations 210, 215 that are associated with those regions and have a 90% success rate for first time talk with those base stations. It may not be necessary, however, for the radio channel to be changed from its previous setting of channel A. In one embodiment, the roving unit changes channels when its leaves a particular region rather than when it enters a particular region. Thus, if the roving unit travels from point A to point B, the roving unit will not unnecessary change channels from the channel A associated with region 300 to the channel B associated with region 310. Unnecessary channel changes are accordingly avoided.

Assuming that the roving unit continues traveling along track 302 from point B to point C, it will enter user-defined region 315. This user-defined region 315, for example, can be an area at or around a plant, a rail yard, a fuel depot, or any other area of interest. When the roving unit enters region 315, a particular event as specified in the database can be executed. For example, a plant manager could be notified that the train is within 10 miles of the plant and that the gates need to be opened to receive the train.

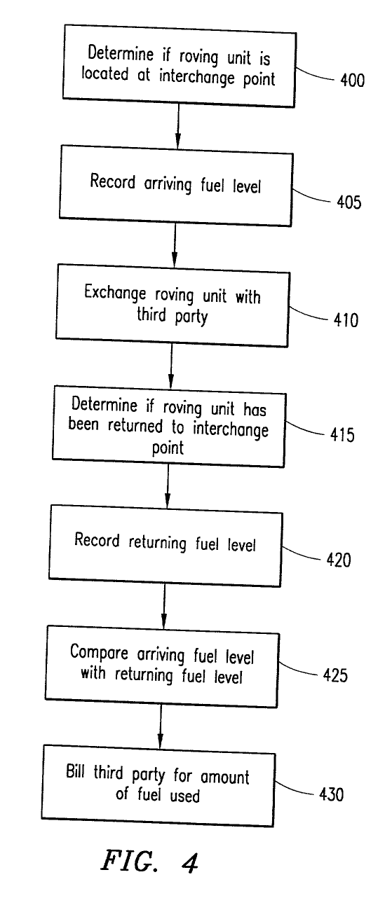

Referring now to FIG. 4, there is shown a flow chart of another application of the present invention. Before discussing the steps shown in FIG. 4, however, an introduction to the particular problem being addressed is useful. In the railroad industry, an interchange point is a location where responsibility for operating a train changes from one company to another company. When a locomotive owned by Company A is taken from an interchange point by Company B, it should be returned by Company B with the same amount of fuel as when it left. Unfortunately, locomotives are often returned to an interchange point with significantly less fuel than when they left. Obviously, Company B's failure to refuel the locomotive incurs significant costs by Company A to actually perform the refueling.

The method described with relation to FIG. 4 addresses this refueling issue and can easily be adapted for roving units other than locomotives and for tasks other than refueling. As one example, consider a railroad locomotive traveling through a certain area where speed is a concern (for safety or enforcement issues). The region could be defined for that certain area and the triggered event would be a recording and/or reporting of locomotive speed when located within the region. As another example, again consider a railroad locomotive operating in an area with significant grades. The region could be defined to cover that area and the triggered event would be a recording and/or reporting of brake pipe pressure.

In this embodiment, an initial determination is made as to whether a roving unit is located within an interchange point as defined by a user-defined region (step 400). A determination of direction may also be needed with respect to step 400. If it is determined that the roving unit is within the interchange point (see steps 110, 115 of FIG. 1), the arriving fuel level is recorded (step 403 and step 120 of FIG. 1) and at least one of stored locally or transmitted to a central unit. Next, the roving unit is exchanged with a third party that leaves the interchange point with the roving unit (step 410). This is detected by steps 110 and 115 of FIG. 1. In one embodiment, the time that the third party leaves the interchange point is recorded. Additionally, in one embodiment, the third party's identity is noted based on the implicated interchange point. When the roving unit is returned to the interchange point (as determined by the roving unit entering the region defining the interchange point (step 415 and see steps 110 and 115 of FIG. 1)), the returning fuel level is recorded and/or transmitted to a central unit (step 420 and step 120 of FIG. 1). Next, the arriving fuel level and returning fuel level are compared to determine whether or not the locomotive has been properly refueled (step 425). If the locomotive has not been refueled, the amount of fuel used is calculated and the third party is billed (step 430). Thus, the present invention can provide a way to automatically track fuel usage and bill the appropriate parties, thereby reducing refueling and fuel monitoring costs. It should also be recognized that fuel levels may be measured before and after fueling at a fuel pit (or depot) in order to determine the amount of fuel added for comparison to re-fueling bills received from third-party contractors.

To summarize, the invention presents a two-fold benefit: first, at the central unit, it assists in the generation of reports which identify roving unit positions, not in terms of latitude and longitude, but rather in terms place names more familiar to people such as “at the ABC Refinery.” Such reports are much more useful than simple “dots on a map” descriptions for use in managing mobile assets. Second, at the roving unit, actions can be triggered by entering and leaving a certain region (like radio channel changing and fuel reporting as discussed above). Other roving unit operation factors (like speed, direction, and the like) can also be reported triggered by region detection to add more value to mobile asset management. Other benefits and uses have been described above.

In conclusion, the present invention provides a system and method for event execution responsive to a roving unit's location. Those skilled in the art, however, can readily recognize that numerous variations and substitutions may be made in the invention, its use and its configuration to achieve substantially the same results a3 achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method comprising the steps of:
determining a location of a roving unit;
determining a defined geographic region in which the determined location of the roving unit lies;
identifying an event that has been defined to be executed when the roving unit is located within the defined region; and
executing the identified event.

2. The method of claim 1, wherein the step of determining the location of the roving unit comprises the step of:
utilizing a GPS to determine the location of the roving unit.

3. The method of claim 1, wherein the step of determining the location of the roving unit comprises the step of:
utilizing a differential GPS to determine the location of the roving unit.

4. The method of claim 1, wherein the event is changing radio channels and the step of executing the identified event comprises the step of:
changing a channel on a mobile radio to a channel for a base station associated with the defined region in which the roving unit lies, wherein the mobile radio is associated with the roving unit.

5. The method of claim 1, wherein the event is an operation mode change and the step of executing the event comprises the step of:
changing a mode of operation of a wireless communication device, wherein the wireless communications device is associated with the roving unit.

6. The method of claim 1, wherein the step of executing the identified event comprises the step of:
changing a location reporting interval, wherein the location reporting interval indicates a time interval between one execution of the step of determining a defined region and a subsequent execution of the step of determining a defined region.

7. The method of claim 1, wherein the step of executing the identified event comprises the step of:
changing a method of determining the location of the roving unit.

8. The method of claim 1, wherein the step of executing the identified event comprises the step of:
generating a notification of the determined location of the roving unit.

9. The method of claim 8, wherein certain geographic regions are associated with place names, and wherein the step of generating comprises the step of:
providing the associated place name for the determined location.

10. The method of claim 1, wherein the step of executing the identified event comprises the step of:
taking a sensor reading, wherein the sensor reading is related to a condition of the roving unit.

11. The method of claim 10, wherein the step of taking a sensor reading comprises the step of:
taking a fuel level reading for the roving unit.

12. The method of claim 10, further comprising the step of:
recording the sensor reading.

13. A system comprising:
at least a first processor for executing instructions;
at least a first memory device connected to the at least a first processor; and
a plurality of instructions stored on the at least a first memory device, the plurality of instructions configured to cause the at least a first processor to:
receive a location indication of a roving unit;
determine a defined region in which the location indication lies;
identify an executable event that corresponds to the defined region, the identified executable event being defined to be executed when the roving unit is located within the defined region; and
execute the identified executable event.

14. The system of claim 13, wherein the plurality of instructions are configured to cause the at least a first processor to:
utilize a GPS to determine the location of the roving unit.

15. The system of claim 13, wherein the plurality of instructions are configured to cause the at least a first processor to:
utilize a differential GPS to determine the location of the roving unit.

16. The system of claim 13, wherein the identified executable event comprises:
changing a channel on a mobile radio to a channel for a base station associated with the defined region in which the roving unit lies, wherein the mobile radio is associated with the roving unit.

17. The system of claim 13, wherein the event is an operation mode change and the identified executable event comprises:
changing a mode of operation of a wireless communication device, wherein the wireless communications device is associated with the roving unit.

18. The system of claim 13, wherein the identified executable event comprises:
changing an event interval, wherein the interval indicates the time interval between one execution of the step of determining a defined region and a subsequent execution of the step of determining a defined region.

19. The system of claim 13, wherein the identified executable event comprises:
changing a method of determining the location of the roving unit.

20. The system of claim 13, wherein the identified executable event comprises:
generating a notification of the determined location of the roving unit.

21. The system of claim 20, wherein certain defined regions are associated with place names, and wherein the determined location comprises the associated place name.

22. The system of claim 13, wherein the identified executable event comprises:
taking a sensor reading, wherein the sensor reading is related to a condition of the roving unit.

23. The system of claim 13, wherein the executable event comprises:
taking a fuel level reading.

24. The system of claim 13, wherein the identified executable event comprises:
recording the sensor reading.

25. A communication system comprising:
a radio operable in at least a first mode and a second mode, wherein the radio is configured to communicate with a first base station associated with a first geographic region when the radio is operating in the first mode and wherein the radio is configured to communicate with a second base station associated with a second geographic region when the radio is operating in the second mode;
location determining means configured to determine the geographic location of the radio; and
a logic device connected to the radio and to the location determining means, the logic device configured at least to change the operation of the radio between the first mode and the second mode responsive to the location determining means determining that the geographic location of the radio is within the second region.

26. The communication system of claim 25, wherein the location determining means comprises:
a GPS receiver.

27. The communication system of claim 25, wherein the radio is constructed according to APCO25.

28. The communication system of claim 25, wherein the first geographic region and the second geographic region partially overlap.
